(19) United States
(12) Patent Application Publication
(10) Pub. No.: US 2019/0285814 A1
(43) Pub. Date: Sep. 19, 2019

(54) OPTICAL SEMICONDUCTOR MODULE

(71) Applicant: Kabushiki Kaisha Toshiba, Tokyo (JP)

(72) Inventors: Hideto FURUYAMA, Yokohama (JP); Yoichiro KURITA, Tokyo (JP); Hiroshi UEMURA, Yokohama (JP)

(73) Assignee: Kabushiki Kaisha Toshiba, Tokyo (JP)

(21) Appl. No.: 16/118,689

(22) Filed: Aug. 31, 2018

(30) Foreign Application Priority Data
Mar. 19, 2018 (JP) 2018-050855

(51) Int. Cl. G02B 6/42

(52) U.S. Cl. CPC G02B 6/4206; G02B 6/4236; G02B 6/4214

(57) ABSTRACT

According to one embodiment, the silicon substrate includes a thinned portion and a side wall provided around the thinned portion. The thinned portion is thinned selectively from one surface. The optical element is formed on a surface of the thinned portion. The surface of the thinned portion is opposite to the one surface of the silicon substrate. The light guide member includes a lens portion, a light guide portion, and an alignment portion. The light guide portion is provided between the lens portion and the optical element. The alignment portion is for an optical connector. The thinned portion of the silicon substrate is provided between the light guide portion of the light guide member and the optical element.

### CROSS-REFERENCE TO RELATED APPLICATION

This application is based upon and claims the benefit of priority from Japanese Patent Application No. 2018-050855, filed on Mar. 19, 2018; the entire contents of which are incorporated herein by reference.

### FIELD

Embodiments described herein relate generally to an optical semiconductor module.

### BACKGROUND

Investigations are being performed for technology in which an optical fiber and an optical element are optically coupled by a blind via formed in a silicon substrate.

### BRIEF DESCRIPTION OF THE DRAWINGS

FIG. 1A is a schematic cross-sectional view of an optical semiconductor module according to a first embodiment, and FIG. 1B is a schematic plan view showing an arrangement example of a silicon substrate and semiconductor elements of the optical semiconductor module according to the first embodiment;

FIG. 2 is an enlarged view of one portion of FIG. 1A;

FIG. 3 is a schematic cross-sectional view showing a bonded structure of the optical semiconductor module according to the first embodiment and an optical fiber;

FIG. 4 is a schematic cross-sectional view showing a method for bonding the optical semiconductor module according to the first embodiment and an optical fiber;

FIG. 5 is a schematic cross-sectional view showing another example of the optical semiconductor module according to the first embodiment;

FIG. 6 is a schematic cross-sectional view showing another example of the optical semiconductor module according to the first embodiment;

FIG. 7 is a schematic cross-sectional view showing another example of the bonded structure of the optical fiber and the optical semiconductor module according to the first embodiment;

FIG. 8 is a schematic cross-sectional view showing another example of the bonded structure of the optical fiber and the optical semiconductor module according to the first embodiment;

FIG. 9 is a schematic cross-sectional view of an optical semiconductor module according to a second embodiment;

FIG. 10A to FIG. 13 are schematic cross-sectional views showing a method for manufacturing the optical semiconductor module according to a second embodiment;

FIG. 14 is a schematic cross-sectional view showing a method for mounting the optical semiconductor module according to the second embodiment to a board;

FIG. 15 is a schematic cross-sectional view showing a method for bonding the optical fiber and the optical semiconductor module according to the second embodiment;

FIG. 16A is a schematic cross-sectional view of an optical semiconductor module according to a third embodiment, and FIG. 16B is a schematic plan view of a silicon substrate of the optical semiconductor module according to the third embodiment;

FIG. 17 is a schematic cross-sectional view showing another example of the optical semiconductor module shown in FIG. 16A;

FIG. 18A is a schematic cross-sectional view of another example of the optical semiconductor module shown in FIG. 16A, and FIG. 18B is an enlarged cross-sectional view of one portion of FIG. 18A;

FIG. 19A is a schematic cross-sectional view of an optical semiconductor module according to a third embodiment, and FIG. 19B is a schematic plan view of a silicon substrate of the optical semiconductor module shown in FIG. 19A;

FIGS. 20A and 20B are schematic cross-sectional view of another example of the optical semiconductor module shown in FIG. 19A;

FIG. 21 is a schematic cross-sectional view of the optical semiconductor module according to the third embodiment;

FIG. 22A is a schematic cross-sectional view of the optical semiconductor module according to the third embodiment, and FIG. 22B is a schematic plan view showing an arrangement example of a silicon substrate and semiconductor elements of the optical semiconductor module according to the third embodiment;

FIG. 23 is an enlarged view of one portion of FIG. 22A; and

FIG. 24 is a schematic cross-sectional view showing a method for bonding the optical fiber and the optical semiconductor module according to the third embodiment.

### DETAILED DESCRIPTION

According to one embodiment, an optical semiconductor module includes a silicon substrate, an optical element, a light guide member, and a transparent resin. The silicon substrate includes a thinned portion and a side wall. The thinned portion is thinned selectively from one surface of the silicon substrate. The side wall is provided around the thinned portion. The optical element is formed on a surface of the thinned portion. The surface of the thinned portion is opposite to the one surface of the silicon substrate. The light guide member includes a lens portion, a light guide portion, and an alignment portion. The light guide portion is provided between the lens portion and the optical element. The alignment portion is for an optical connector. The transparent resin is provided between the thinned portion of the silicon substrate and the light guide portion of the light guide member. The thinned portion of the silicon substrate is provided between the light guide portion of the light guide member and the optical element. The light guide member is positioned in a direction excluding a direction from the optical element toward the thinned portion by the side wall of the silicon substrate. The light guide member is positioned in the direction from the optical element toward the thinned portion by an outside portion of the light guide member. The outside portion is outside a via provided on the thinned portion of the silicon substrate and being continuous to the light guide portion.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

### First Embodiment

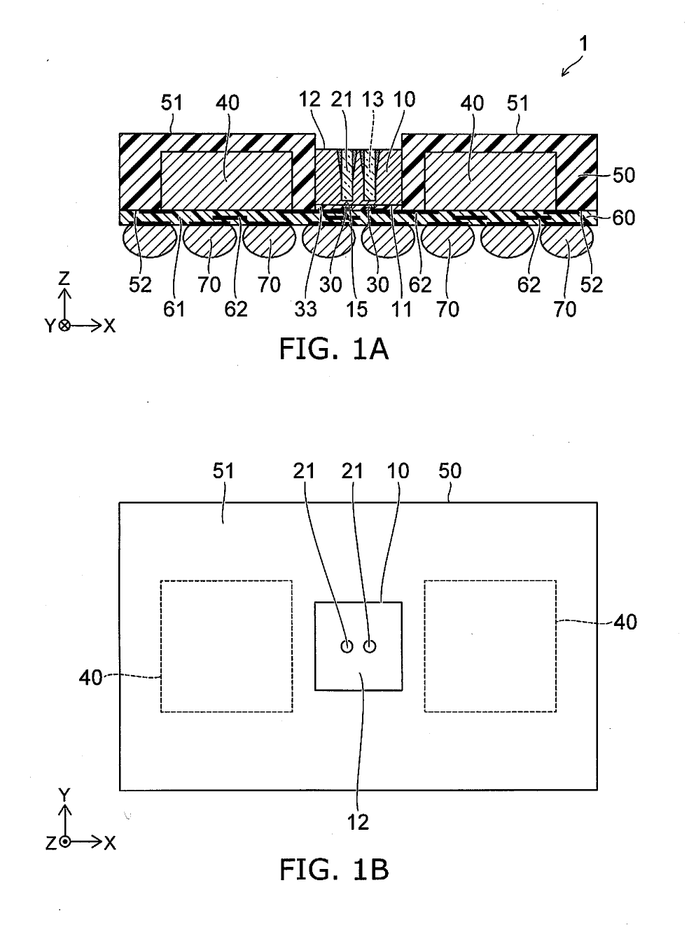

FIG. 1A is a schematic cross-sectional view of an optical semiconductor module 1 according to a first embodiment.

FIG. 1B is a schematic plan view showing an arrangement example of a silicon substrate 10 and semiconductor elements 40 of the optical semiconductor module 1 according to the first embodiment.

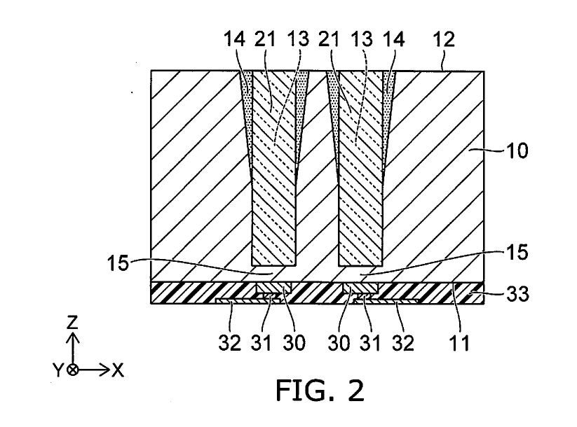

FIG. 2 is an enlarged view of one portion of FIG. 1A.

As shown in FIG. 1A, the optical semiconductor module 1 according to the first embodiment includes an interconnect layer 60, the silicon substrate 10, an optical element 30, a light guide portion 21, the multiple semiconductor elements 40, a resin portion 50, and multiple external terminals 70.

The direction from the interconnect layer 60 toward the silicon substrate 10 and the direction from the interconnect layer 60 toward the semiconductor elements 40 are aligned with a first direction.

The first direction is taken as a Z-axis direction. One direction perpendicular to the Z-axis direction is taken as an X-axis direction. A direction perpendicular to the Z-axis direction and the X-axis direction is taken as a Y-axis direction.

The silicon substrate 10 is provided between the multiple semiconductor elements 40. A second direction from the silicon substrate 10 toward the semiconductor elements 40 crosses the first direction. In the example, the second direction is orthogonal to the first direction and is aligned with the X-axis direction. A third direction crosses the second direction. In the example, the third direction is orthogonal to the first direction and the second direction and is aligned with the Y-axis direction.

For example, the interconnect layer 60 is aligned with the X-Y plane. The multiple external terminals 70 are arranged in the second direction (the X-axis direction) and the third direction (the Y-axis direction) in the X-Y plane. The external terminals 70 are, for example, solder balls. The external terminals 70 may be metal pads or metal bumps.

The interconnect layer 60 is provided between the external terminals 70 and the silicon substrate 10 and between the external terminals 70 and the semiconductor elements 40.

The silicon substrate 10 has a first surface 11 and a second surface 12. The optical element 30 is provided between the first surface 11 and the interconnect layer 60. An insulating layer 33 is further provided between the first surface 11 and the interconnect layer 60. The insulating layer 33 is, for example, a resin layer. The second surface 12 is the surface opposite to the first surface 11.

As shown in FIG. 2, the optical element 30 is provided at the first surface 11 of the silicon substrate 10. The light guide portion 21 is provided inside the silicon substrate 10. The light guide portion 21 extends in the first direction and is provided inside a via 13 extending in the first direction (the Z-axis direction) through the silicon substrate 10.

As shown in FIG. 2, the light guide portion 21 may be an optical fiber. A resin 14 is provided between the light guide portion 21 and the inner wall of the via 13. The number of the light guide portions 21 provided in one silicon substrate 10 is not limited to two and may be one, three, or more.

The via 13 is a blind via that does not pierce through the silicon substrate 10; and one portion 15 of the silicon substrate 10 is provided between the via 13 and the first surface 11. The one portion 15 of the silicon substrate 10 is a thinned portion thinned selectively from the second surface 12 by forming the via 13. The one portion 15 of the silicon substrate 10 is provided between the light guide portion 21 provided inside the via 13 and the optical element 30 provided at the first surface 11. An air gap is not particularly provided between the light guide portion 21 and the optical element 30. The length along the Z-axis direction of the light guide portion 21 is, for example, thinner than the thickness along the Z-axis direction of the silicon substrate 10.

The optical element 30 is a light-emitting element that emits light that can pass through the light guide portion 21 and the silicon substrate 10, or a light receiving element that receives light that can pass through the light guide portion 21 and the silicon substrate 10.

The light guide portion 21 opposes the light-emitting portion or the light receiving portion of the optical element 30 along the Z-axis direction. For example, the light-emitting portion or the light receiving portion of the optical element 30 is positioned on the optical axis of the light guide portion 21.

An AR (antireflection) film may be provided at the surface of the one portion 15 of the silicon substrate 10 (the bottom surface of the via 13). For example, in the case of a single-crystal silicon substrate 10 having a refractive index of about 3.5 and a material of the light guide portion 21 (a resin or glass) having a refractive index of about 1.5, a silicon nitride film that has a refractive index of n=2.3 can be provided at the surface of the one portion 15 of the silicon substrate 10 and can have a film thickness of λ/4n (λ being the wavelength in vacuum of the light incident on the interface recited above).

It is desirable for the optical element 30 to be formed in a state in which the flatness of the silicon substrate 10 is maintained; and it is desirable for the optical element 30 to be formed before the via 13. However, the optical element 30 may be formed after the via 13.

The optical element 30 includes, for example, a semiconductor layer of a Group III-V compound. At least the semiconductor layer of the optical element 30 is bonded to the first surface 11 of the silicon substrate 10 so that the semiconductor layer is in the wafer state or the chip state with the substrate used for the epitaxial growth of the semiconductor layer, and the silicon substrate 10 is in the wafer state.

The semiconductor layer of the optical element 30 is directly bonded to the first surface 11 of the silicon substrate 10. Or, the semiconductor layer of the optical element 30 is bonded to the first surface 11 of the silicon substrate 10 via an oxide film or a bonding layer. Or, for example, the semiconductor layer of the optical element 30 may be epitaxially grown on the first surface 11 of the silicon substrate 10 with a buffer layer interposed.

The optical element 30 is formed on the first surface 11 of the silicon substrate 10 by performing patterning of the semiconductor layer on the first surface 11 of the silicon substrate 10, electrode formation, etc.

The insulating layer 33 may be formed on the first surface 11 of the silicon substrate 10; and the optical element 30 may be covered with the insulating layer 33. Also, a metal interconnect 32 that is connected to an electrode 31 of the optical element 30 can be formed in the insulating layer 33.

For example, the light that is emitted from the optical element 30 that is a light-emitting element passes through the one portion 15 of the silicon substrate 10 between the optical element 30 and the light guide portion 21 and is incident on the light guide portion 21. Also, for example, the light that is guided through the light guide portion 21 toward the optical element 30 that is a light receiving element passes through the one portion 15 of the silicon substrate 10 and is incident on the optical element 30.

Because the via 13 does not pierce through the silicon substrate 10, it is possible to form the optical element 30 on the first surface 11 of the silicon substrate 10. The silicon substrate 10 has the functions of fixing the light guide portion 21 and fixing the optical element 30 on the optical axis of the light guide portion 21.

The thickness along the Z-axis direction of the silicon substrate 10 is, for example, 200 to 400 μm. The light that is incident on the light guide portion 21 from an external optical fiber described below or the light that is incident on the light guide portion 21 from the optical element 30 is guided in the Z-axis direction through the light guide portion 21 without being diffused inside the silicon substrate 10.

The optical coupling between the light guide portion 21 and the optical element 30 can be ensured by setting the distance along the Z-axis direction between the light guide portion 21 and the optical element 30 to be, for example, several tens of μm.

As shown in FIG. 1A, the interconnect layer 60 includes an insulating layer 61 and a conductive member 62. The conductive member 62 includes, for example, a metal interconnect. For example, the conductive member 62 is connected to the external terminals 70. Further, for example, the conductive member 62 is connected to the metal interconnect 32 shown in FIG. 2. Accordingly, the optical element 30 may be electrically connected to the external terminals 70 via the conductive member 62 of the interconnect layer 60.

Further, the conductive member 62 of the interconnect layer 60 electrically connects the semiconductor elements 40 and the external terminals 70. The optical element 30 may be electrically connected to the semiconductor elements 40 via the conductive member 62 of the interconnect layer 60. The semiconductor elements 40 include, for example, a driver or a receiver of the optical element 30.

The resin portion 50 is provided between the silicon substrate 10 and the semiconductor elements 40. The resin portion 50 covers the semiconductor elements 40. Further, the resin portion 50 covers the side surface of the silicon substrate 10. The side surface crosses the X-Y plane.

The resin portion 50 does not cover the second surface 12 of the silicon substrate 10. A portion of the resin portion 50 does not overlap the silicon substrate 10 in the first direction (the Z-axis direction).

The resin portion 50 has a first resin surface 52 and a second resin surface 51. The first resin surface 52 opposes the interconnect layer 60 along the first direction (the Z-axis direction). The second resin surface 51 is the surface opposite to the first resin surface 52.

In the example shown in FIG. 1A, the distance along the Z-axis direction between the interconnect layer 60 and the second resin surface 51 is longer than the distance along the Z-axis direction between the interconnect layer 60 and the second surface 12 of the silicon substrate 10.

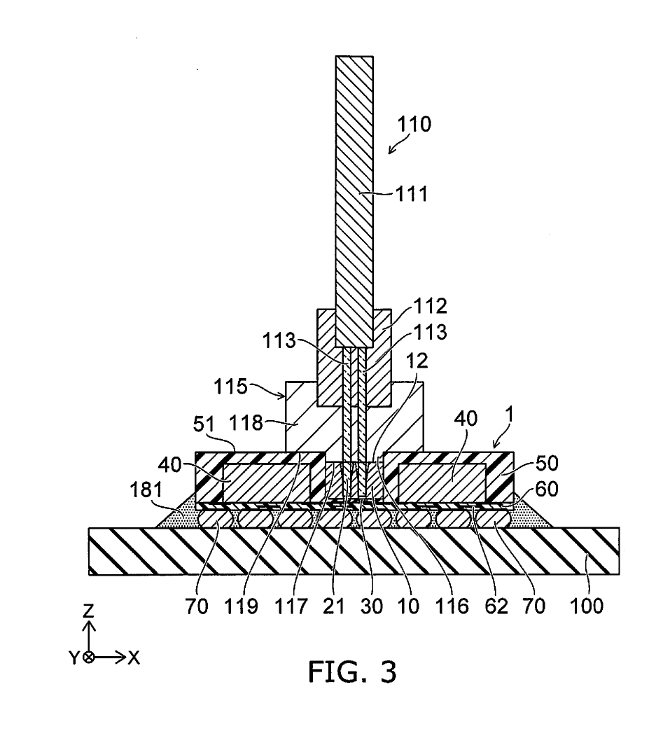

FIG. 3 is a schematic cross-sectional view showing the bonded structure of the optical semiconductor module 1 according to the first embodiment and an external optical fiber 113.

The optical semiconductor module 1 is mounted to a board 100. The board 100 is, for example, a PWB (printed wiring board). The external terminals 70 of the optical semiconductor module 1 are bonded to a not-illustrated conductive member of the board 100. A resin 181 is provided at the bonding portion between the board 100 and the external terminals 70.

An optical connector 115 is connected to the optical semiconductor module 1. The optical connector 115 is assembled on the end portion of an optical fiber cable 110. The optical fiber cable 110 includes the multiple optical fibers 113, a cover portion 111 that covers the multiple optical fibers 113, and an optical fiber boot 112 that is provided between the optical connector 115 and the end portion of the cover portion 111. One end portion of the optical fiber 113 is not covered with the cover portion 111 and extends in the first direction (the Z-axis direction) through the interior of the optical connector 115.

The optical connector 115 includes a first portion 116 provided in the region where the optical fiber 113 passes through, and a second portion 118 provided at the periphery of the first portion 116. The optical fiber 113 pierces the first portion 116 between the cover portion 111 and the silicon substrate 10 of the optical semiconductor module 1.

The first portion 116 has a first bonding surface 117 opposing the second surface 12 of the silicon substrate 10 along the first direction (the Z-axis direction). The second portion 118 has a second bonding surface 119 opposing the second resin surface 51 of the resin portion 50 along the first direction.

The optical fiber 113 inside the optical connector 115 and the light guide portion 21 inside the silicon substrate 10 are optically coupled so that the optical axes match each other. The light guide portion 21 inside the silicon substrate 10 is, for example, a relay optical fiber that optically connects between the external optical fiber 113 and the optical element 30 of the optical semiconductor module 1.

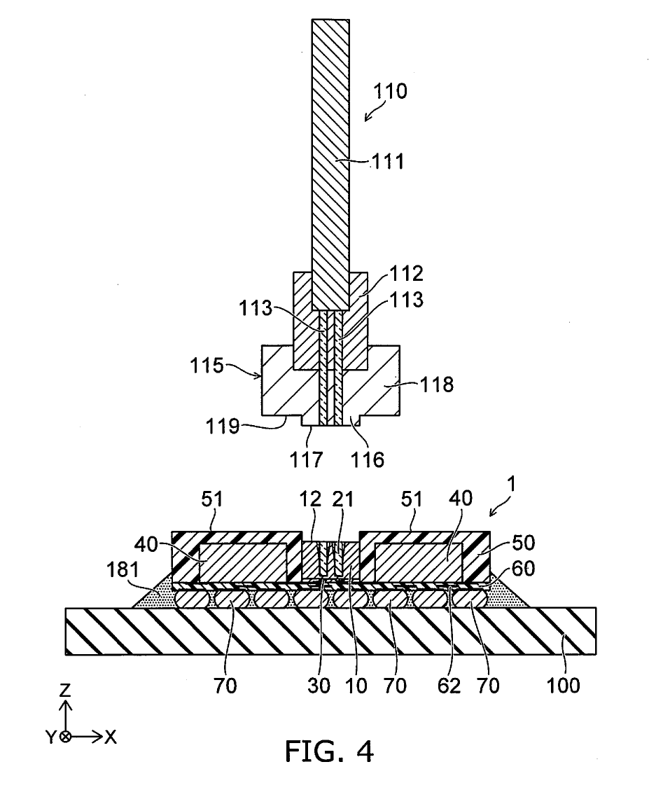

FIG. 4 is a schematic cross-sectional view showing a method for connecting the optical fiber 113 and the optical semiconductor module 1 according to the first embodiment.

As shown in FIG. 4, the optical semiconductor module 1 is mounted to the board 100 before connecting the optical connector 115 on which the optical fiber 113 is assembled. For example, the external terminals 70 which are solder balls are reflow-connected to the conductive member of the board 100. The reflow connection in the state in which the optical connector 115 and the optical fiber 113 are not bonded makes the reflow process easy.

Then, after the optical semiconductor module 1 is mounted to the board 100, the optical connector 115 is connected to the optical semiconductor module 1. For example, as shown in FIG. 3, the first bonding surface 117 of the optical connector 115 is bonded to the second surface 12 of the silicon substrate 10; and the second bonding surface 119 of the optical connector 115 is bonded to the second resin surface 51 of the resin portion 50.

For example, because the first portion 116 of the optical connector 115 contacts the portion of the resin portion 50 not overlapping the silicon substrate 10 in the Z-axis direction, the movement of the optical connector 115 in the X-direction and the Y-direction is regulated; and the optical fiber 113 is aligned with the light guide portion 21 inside the silicon substrate 10. At this time, the optical connector 115 may be fixed to the optical semiconductor module 1 by a resin.

According to the first embodiment, the optical fiber 113 can be mounted to the optical semiconductor module 1 easily without special technology or processes after the board mounting service provider mounts the optical semiconductor module 1 to the board 100. It is unnecessary to insert the optical fiber 113 directly into the via 13 of the silicon substrate 10. The optical connection of the external optical fiber 113 to the optical element 30 is possible using a simple bonding method using the optical connector 115. This makes it possible to suppress the fluctuation of the optical fiber mounting work quality and to inexpensively provide a highly-reliable assembly.

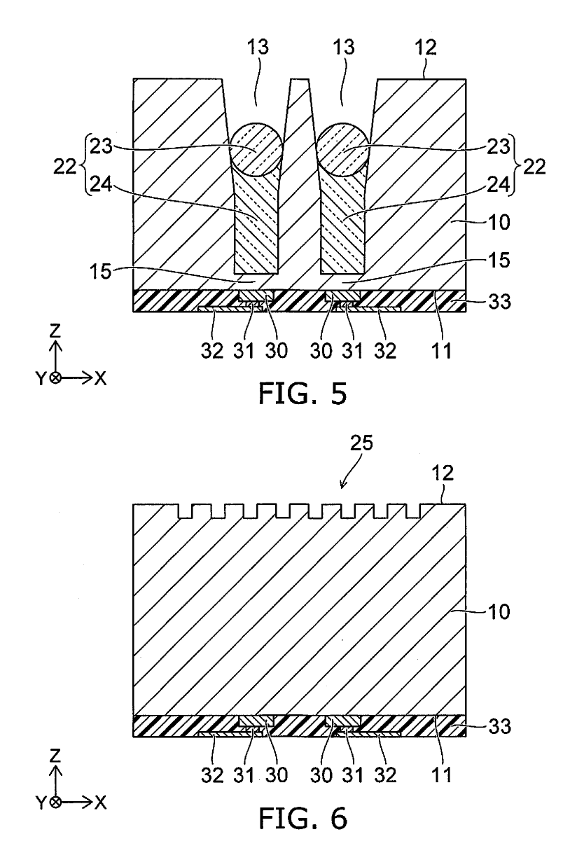

FIG. 5 is a schematic cross-sectional view showing another example of the optical semiconductor module according to the first embodiment.

A light guide portion 22 is provided inside the silicon substrate 10. The light guide portion 22 extends in the first direction and is provided inside the via 13 extending in the first direction (the Z-axis direction) through the silicon substrate 10. The light guide portion 22 shown in FIG. 5 includes a condensing lens 23 and a light-transmitting member 24. The condensing lens 23 is, for example, a spherical lens of a resin or glass. The light-transmitting member 24 is, for example, a member of a resin or glass formed in a columnar configuration extending in the Z-axis direction.

The one portion 15 of the silicon substrate 10 is provided between the light guide portion 22 provided inside the via 13 and the optical element 30 provided at the first surface 11 of the silicon substrate 10. The light-transmitting member 24 is provided between the condensing lens 23 and the one portion 15 of the silicon substrate 10. The one portion 15 of the silicon substrate 10 is provided between the light-transmitting member 24 and the optical element 30.

An air gap is not particularly provided between the light guide portion 22 and the optical element 30. For example, the length along the Z-axis direction of the light guide portion 22 is thinner than the thickness along the Z-axis direction of the silicon substrate 10.

The light guide portion 22 opposes the light-emitting portion or the light receiving portion of the optical element 30 along the Z-axis direction. For example, the light-emitting portion or the light receiving portion of the optical element 30 is positioned on the optical axis of the light guide portion 22.

An AR film may be provided at the surface of the one portion 15 of the silicon substrate 10.

The focal length can be controlled by the curvature and/or the position in the Z-axis direction of the condensing lens 23.

FIG. 6 is a schematic cross-sectional view showing another example of the optical semiconductor module according to the first embodiment.

The silicon substrate 10 shown in FIG. 6 includes a diffractive lens 25 provided in the second surface 12 opposite to the first surface 11 where the optical element 30 is provided. A via is not formed in the silicon substrate 10.

The diffractive lens 25 includes multiple unevennesses formed in the second surface 12. For example, the multiple unevennesses are formed periodically in a concentric circular configuration having the optical axis as a center.

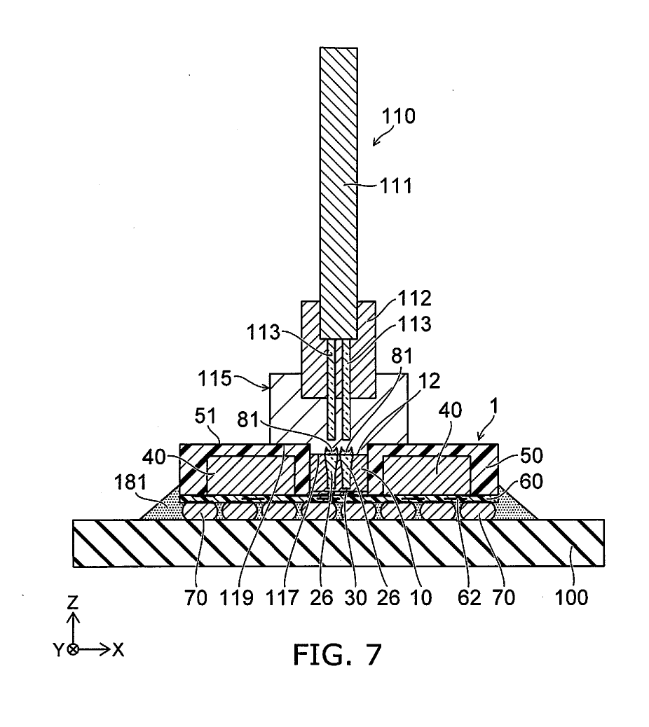

FIG. 7 is a schematic cross-sectional view showing another example of the bonded structure of the optical fiber 113 and the optical semiconductor module 1 according to the first embodiment.

A light guide portion 26 that extends in the first direction (the Z-axis direction) is provided inside the silicon substrate 10. The light guide portion 26 is, for example, a resin or glass having a columnar configuration.

A condensing lens 81 is provided at the first bonding surface 117 of the optical connector 115 and the optical axis matches to the optical axis of the light guide portion 26. The condensing lens 81 is, for example, a convex lens of a resin or glass and opposes the light guide portion 26 with an air gap interposed.

Inside the optical connector 115, the optical fiber 113 does not pierce through the optical connector 115; and a portion of the optical connector 115 is provided between the condensing lens 81 and one end of the optical fiber 113. The material of the optical connector 115 is a resin or glass; the light that is emitted from the optical fiber 113 passes through the portion of the optical connector 115 and is incident on the condensing lens 81; and the condensing lens 81 forms a focal point at the optical element 30. Or, the light emitted by the optical element 30 is guided through the light guide portion 26 inside the silicon substrate 10 and is incident on the condensing lens 81; and the condensing lens 81 forms a focal point at the optical fiber 113.

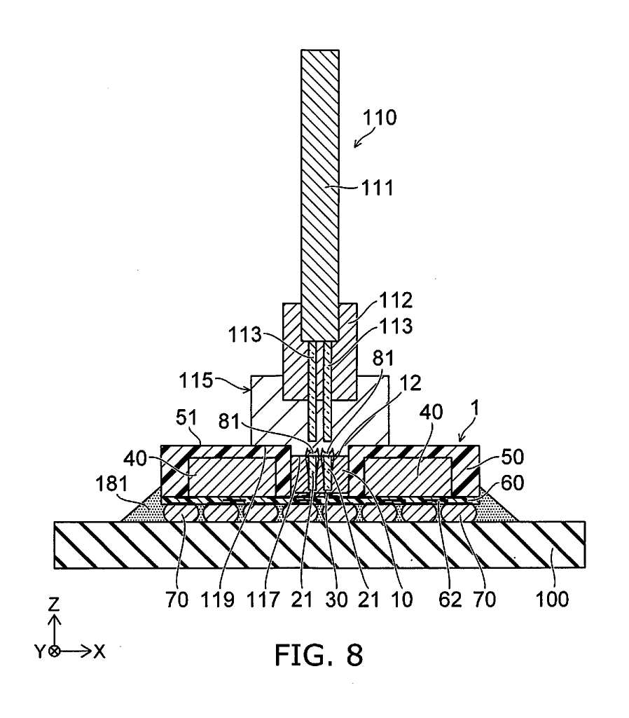

FIG. 8 shows an example of the combination of the condensing lens 81 shown in FIG. 7 and the light guide portion 21 shown in FIG. 2. The light guide portion 21 is, for example, the relay optical fiber described above.

### Second Embodiment

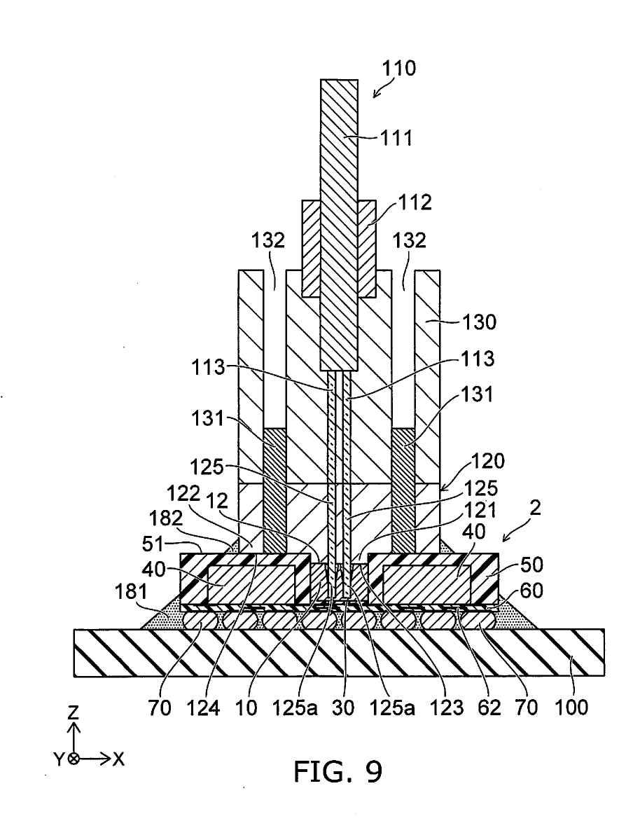

FIG. 9 is a schematic cross-sectional view of an optical semiconductor module 2 according to a second embodiment.

The optical semiconductor module 2 has a configuration similar to the optical semiconductor module 1 shown in FIG. 1A. An optical connector head 120 is bonded to the optical semiconductor module 2. An optical connector 130 is connected to the optical connector head 120.

The optical connector 130 is assembled on the end portion of the optical fiber cable 110. The optical fiber cable 110 includes the multiple optical fibers 113, the cover portion 111 that covers the multiple optical fibers 113, and the optical fiber boot 112 that is provided at the bonding portion between the cover portion 111 and the optical connector 130. One end portion of the optical fiber 113 is not covered with the cover portion 111 and extends in the first direction (the Z-axis direction) through the interior of the optical connector 130.

The optical connector head 120 includes a first portion 121 provided in the region where light guide portion 125 passes through, includes a second portion 122 provided at the periphery of the first portion 121, and is fixed to the optical semiconductor module 2 by a resin 182.

The first portion 121 has a first bonding surface 123 opposing the second surface 12 of the silicon substrate 10 along the Z-axis direction. The second portion 122 has a second bonding surface 124 opposing the second resin surface 51 of the resin portion 50 along the Z-axis direction. The first bonding surface 123 contacts the second surface 12 and regulates the length to which the light guide portion 125 is inserted into the silicon substrate 10. The second bonding surface 124 may contact the second resin surface 51, or may not contact the second resin surface 51 and may be slightly raised.

The light guide portion 125 extends in the Z-axis direction through the optical connector head 120. A portion 125a of the light guide portion 125 is provided inside the silicon substrate 10 and extends in the Z-axis direction through the silicon substrate 10. One portion of the silicon substrate 10 is provided between a light guide portion 125a inside the silicon substrate 10 and the optical element 30 provided at the first surface 11 of the silicon substrate 10. An air gap is not particularly provided between the light guide portion 125a and the optical element 30.

The light guide portion 125 and the optical fiber 113 inside the optical connector 130 are optically coupled so that the optical axes match each other. The light guide portion 125 is, for example, a relay optical fiber that optically connects between the external optical fiber 113 and the optical element 30 of the optical semiconductor module 2.

A guide member 131 extends in the Z-axis direction through the interior of the second portion 122 of the optical connector head 120. A portion of the guide member 131 is inserted into a guide hole 132 formed in the optical connector 130.

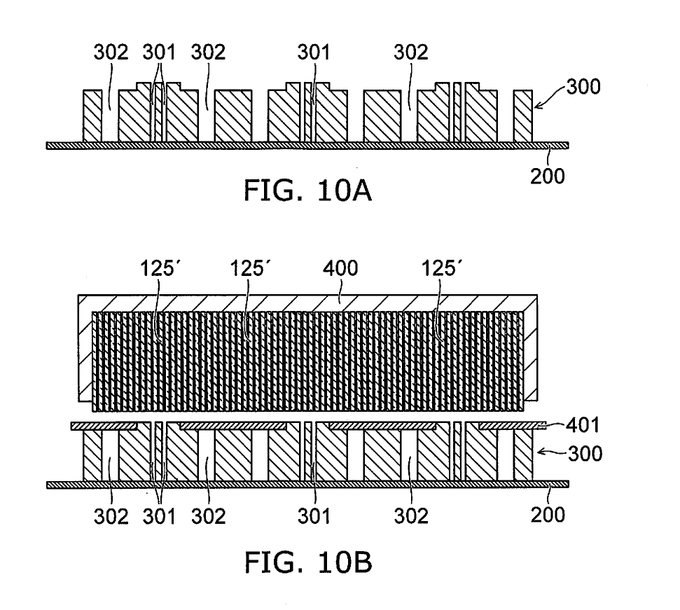

FIG. 10A to FIG. 12B are schematic cross-sectional views showing a method for manufacturing the optical connector head 120.

As shown in FIG. 10A, multiple first holes 301 and multiple second holes 302 are formed in an optical connector head substrate 300 fixed to a mold tape 200. The first holes 301 and the second holes 302 extend in the thickness direction of the optical connector head substrate 300 and pierce the optical connector head substrate 300. The optical connector head substrate 300, the multiple first holes 301, and the multiple second holes 302 may be formed by resin-molding using a mold.

After forming the first holes 301 and the second holes 302, the inlets of the second holes 302 are covered with a mask 401 as shown in FIG. 10B. The mask 401 is, for example, a metal mask. A bundle of multiple optical fibers 125′ held by a holding member 400 is caused to approach the optical connector head substrate 300.

The multiple optical fibers 125′ fall or are moved toward the optical connector head substrate 300, for example, auxiliary means for applying ultrasonic waves may be used; and the optical fibers 125′ are inserted into the first holes 301. The optical fibers 125′ are not inserted into the second holes 302 that are covered with the mask 401.

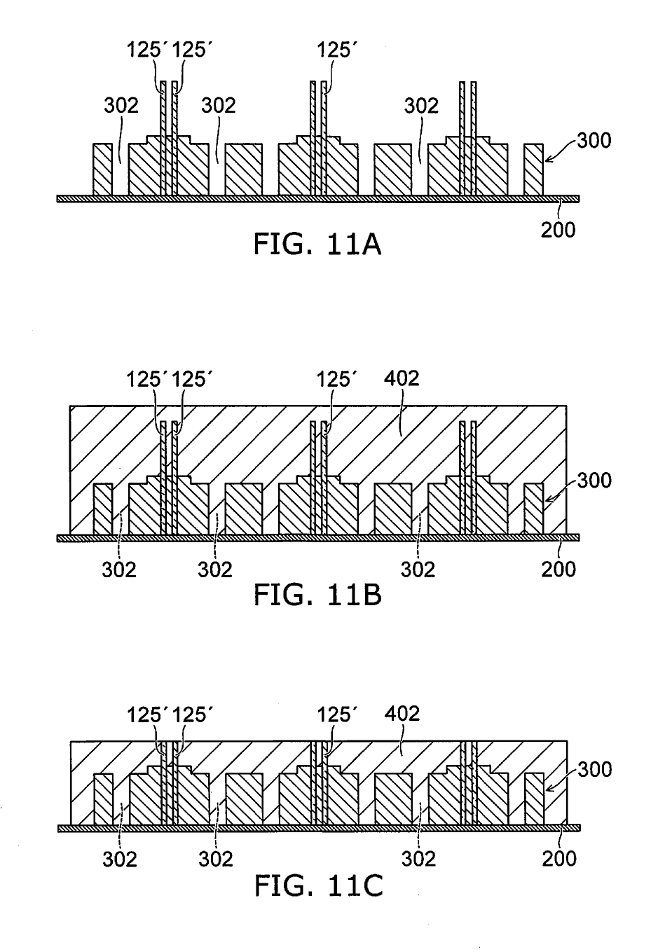

As shown in FIG. 11A, the optical fibers 125′ are inserted respectively into the first holes 301. Portions of the optical fibers 125′ inserted into the first holes 301 protrude from the first holes 301.

The portions of the multiple optical fibers 125′ protruding from the first holes 301 are covered with a sacrificial layer 402 as shown in FIG. 11B. For example, the sacrificial layer 402 is formed by performing thermal curing of a liquid resin material supplied to the interior of a mold.

The portions of the multiple optical fibers 125′ protruding from the first holes 301 are polished with the sacrificial layer 402; and the lengths of the optical fibers 125′ are adjusted as shown in FIG. 11C.

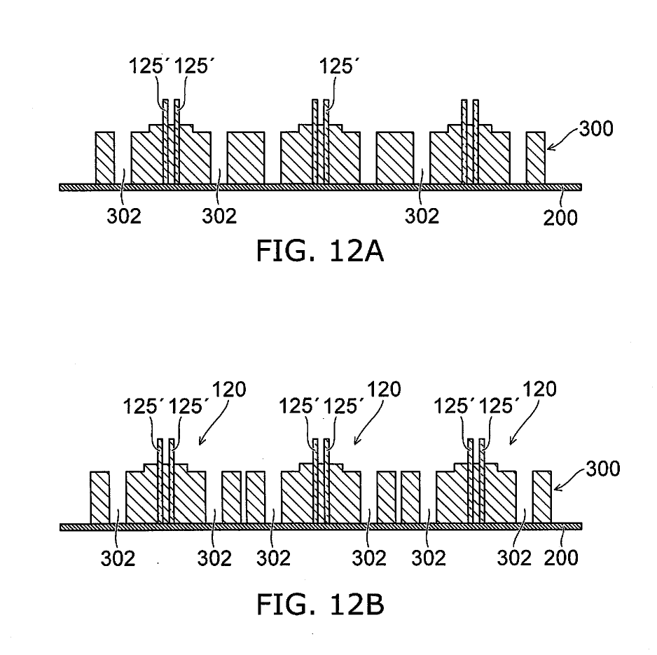

Subsequently, the sacrificial layer 402 is removed as shown in FIG. 12A. After removing the sacrificial layer 402, the optical connector head substrate 300 is separated into the multiple optical connector, heads 120 as shown in FIG. 12B. The optical fibers 125′ become the light guide portions 125 described above. The sacrificial layer 402 may be removed after separating the optical connector head substrate 300 into the multiple optical connector heads 120.

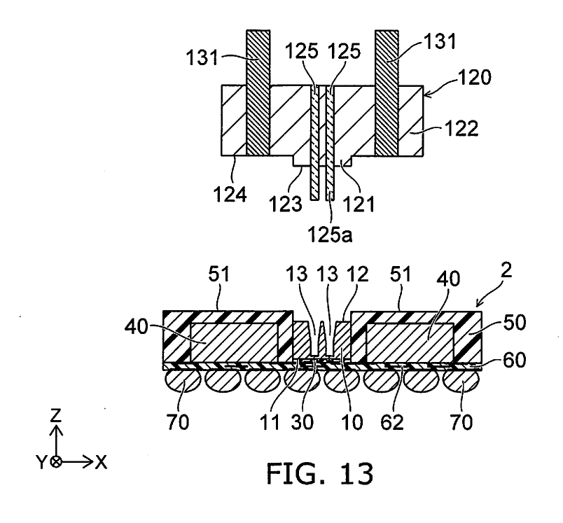

Also, the guide members 131 shown in FIG. 13 are press-fitted into the second holes 302 of the optical connector head 120.

FIG. 13 is a schematic cross-sectional view showing a method for manufacturing the optical semiconductor module according to the second embodiment.

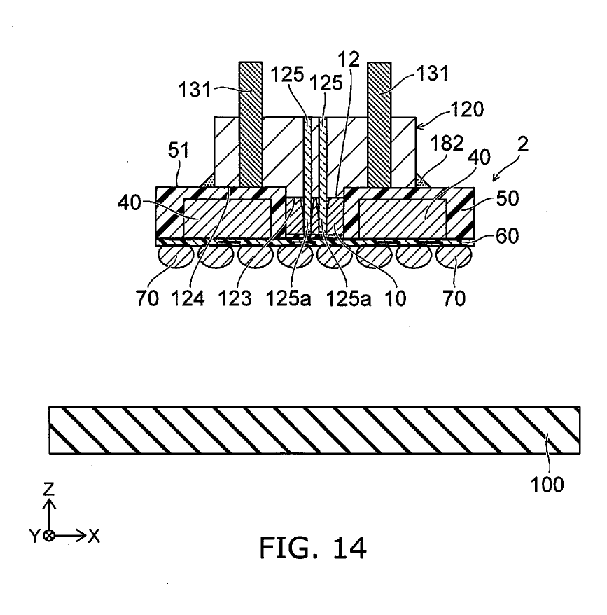

FIG. 14 is a schematic cross-sectional view showing a method for mounting the optical semiconductor module according to the second embodiment to a board.

The optical connector head 120 that includes the optical fiber as the light guide portion 125 as described above is bonded to the optical semiconductor module 2. For example, the first bonding surface 123 of the optical connector head 120 contacts the second surface 12 of the silicon substrate 10 and regulates the insertion depth of the light guide portion 125. The second bonding surface 124 of the optical connector head 120 may contact the second resin surface 51 of the resin portion 50, or may not contact the second resin surface 51 and may be slightly raised. The optical connector head 120 and the optical semiconductor module 2 are fixed by the resin 182.

The portion 125a of the light guide portion 125 protruding from the optical connector head 120 is inserted into the via 13 formed in the silicon substrate 10. The via 13 is a blind via that does not pierce through the silicon substrate 10; and one portion of the silicon substrate 10 is provided between the via 13 and the first surface 11 of the silicon substrate 10.

As shown in FIG. 14, a bonding agent 182 is provided at the bonding portion between the optical connector head 120 and the resin portion 50. Also, a bonding agent is provided between the inner wall of the via 13 and the light guide portion 125a.

The light guide portion 125a that is inside the via 13 opposes the light-emitting portion or the light receiving portion of the optical element 30 along the Z-axis direction. For example, the light-emitting portion or the light receiving portion of the optical element is positioned on the optical axis of the light guide portion 125a.

Before connecting the optical connector 130 on which the optical fiber 113 is assembled, the optical semiconductor module 2 that is bonded to the optical connector head 120 is mounted to the board 100. For example, the external terminals 70 which are solder balls are reflow-connected to the conductive member of the board 100. The reflow connection that is performed in the state in which the external optical fiber 113 is not bonded makes the reflow process easy.

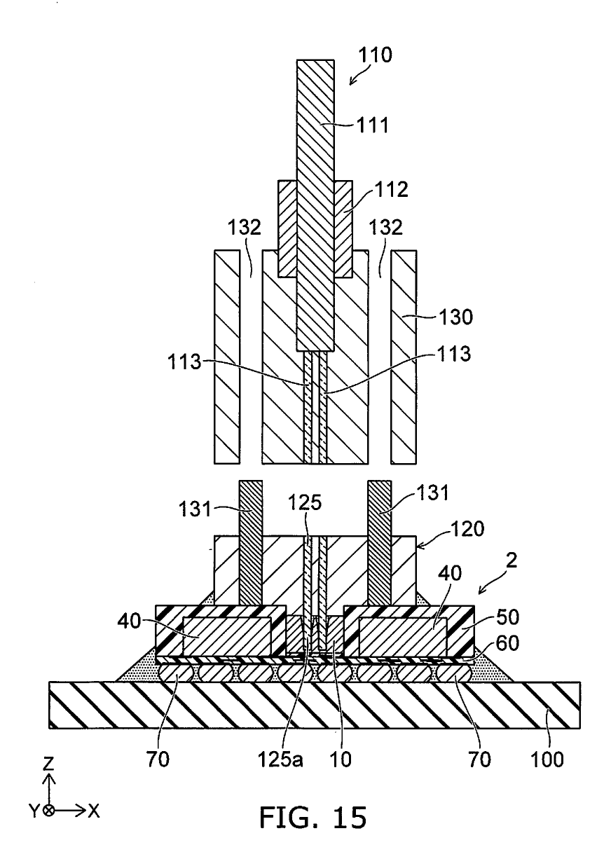

FIG. 15 is a schematic cross-sectional view showing a method for bonding the optical fiber 113 and the optical semiconductor module 2 according to the second embodiment.

The optical connector 130 is bonded to the optical connector head 120; and the optical fiber 113 that is held by the optical connector 130 is optically coupled to the light guide portion 125 inside the optical connector head 120. The guide member 131 of the optical connector head 120 is inserted into the guide hole 132 of the optical connector 130; the movement of the optical connector 130 in the X-direction and the Y-direction is regulated; and the optical fiber 113 is aligned with the light guide portion 125.

According to the second embodiment, the optical fiber 113 can be mounted to the optical semiconductor module 2 easily without special technology or processes after the board mounting service provider mounts the optical semiconductor module 2 to the board 100. It is unnecessary for the board mounting service provider to insert the optical fiber 113 directly into the via of the silicon substrate 10. The external optical fiber 113 can be optically connected to the optical element 30 by a simple bonding method for bonding the optical connector 130 to the optical connector head 120. This makes it possible to suppress the fluctuation of the optical fiber mounting work quality and inexpensively provide a highly-reliable assembly.

### Third Embodiment

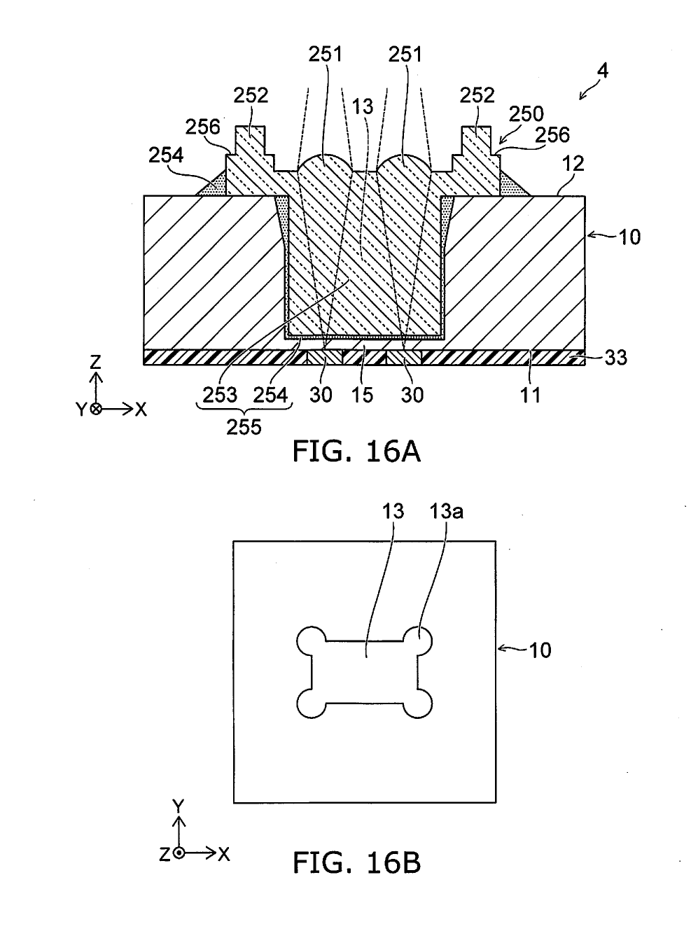

FIG. 16A is a schematic cross-sectional view of an optical semiconductor module 4 according to a third embodiment.

FIG. 16B is a schematic plan view of the silicon substrate 10 of the optical semiconductor module 4 according to the third embodiment.

The optical semiconductor module 4 includes the silicon substrate 10, the optical element 30, and a light guide member 250.

As shown in FIG. 16A, the silicon substrate 10 has the first surface 11 and the second surface 12. The optical element 30 and the insulating layer 33 are provided at the first surface 11. The insulating layer 33 is, for example, a resin layer or a silicon oxide layer. The second surface 12 is the surface opposite to the first surface 11.

As shown in FIG. 16B, the via 13 is provided in the silicon substrate 10. The opening configuration of the via 13 is not limited to a quadrilateral and may be any configuration combinable with the light guide member 250 described below such as a triangle, a circle, an ellipse, a hexagon, etc. Here, although a light guide portion 253 of the light guide member 250 described below is taken to be a quadrilateral prism, for example, a relief portion 13a may be provided in the via 13 as shown in FIG. 16B so that an excess of a transparent bonding agent 254 is pushed out when providing the transparent bonding agent 254 described below.

The via 13 is a blind via that does not pierce through the silicon substrate 10; and the thinned portion 15 of the silicon substrate 10 is provided between the via 13 and the first surface 11 as shown in FIG. 16A. The thinned portion 15 is a portion that is thinned selectively from the second surface 12 by forming the via 13. The silicon substrate 10 includes a side wall provided around the thinned portion 15. The thinned portion 15 is thinner than the portion of the silicon substrate 10 at the periphery of the via 13, the portions of the silicon substrate 10 sandwiching the via 13 in the X-axis direction, or the portions of the silicon substrate 10 sandwiching the via 13 in the Y-axis direction.

It is desirable for the optical element 30 to be formed at the first surface 11 in a state in which the flatness of the silicon substrate 10 is maintained; and it is desirable for the optical element 30 to be formed before the via 13. However, the optical element 30 may be formed after the via 13.

Because the via 13 does not pierce through the silicon substrate 10, it is possible to form the optical element 30 at the first surface 11 of the silicon substrate 10.

After forming the optical element 30, the insulating layer 33 is formed at the first surface 11 of the silicon substrate 10; and the optical element 30 may be covered with the insulating layer 33. A metal interconnect that is connected to the electrode of the optical element 30 also can be formed in the insulating layer 33.

The light guide member 250 includes a lens portion 251, the light guide portion 253, an alignment portion 252, and a stopper portion 256. The material of the light guide member 250 is transmissive to the light emitted or received by the optical element 30. The light guide member 250 is, for example, a resin member in which the lens portion 251, the light guide portion 253, and the alignment portion 252 are provided as one body. The light guide member 250 is, for example, a molded lens adapter obtained by molding a resin material.

The light guide portion 253 is provided inside the via 13 of the silicon substrate 10. The transparent bonding agent (or transparent resin) 254 is provided between the light guide portion 253 and the side surface of the via 13 and between the light guide portion 253 and the bottom surface of the via 13. The transparent bonding agent 254 contacts the light guide portion 253 and the thinned portion 15 of the silicon substrate 10. The material of the transparent bonding agent 254 is transmissive to the light emitted or received by the optical element 30 and is, for example, a resin material.

There are also cases hereinbelow where the light guide portion 253 and the transparent bonding agent 254 are collectively referred to as a light guide portion 255 of the light guide member 250. The light guide portion 255 that includes the light guide portion 253 and the transparent bonding agent 254 is provided between the lens portion 251 and the optical element 30.

The light guide portion 255 is provided inside the via 13 of the silicon substrate 10.

The direction from the optical element 30 toward the lens portion 251 is aligned with the first direction. The first direction is taken as the Z-axis direction. One direction perpendicular to the Z-axis direction is taken as the X-axis direction. A direction perpendicular to the Z-axis direction and the X-axis direction is taken as the Y-axis direction.

The lens portions 251 are provided outside the via 13 of the silicon substrate 10. The multiple lens portions 251 that correspond to the multiple optical elements 30 are provided to be continuous with the light guide portions 253 outside the via 13. The lens portions 251 are, for example, convex lenses; and the tips are retracted toward the light guide portion 253 side from the stopper portion 256.

The light guide portion 255 is provided between the lens portions 251 and the optical element 30. The thinned portion 15 of the silicon substrate 10 is provided between the light guide portion 255 and the optical element 30.

For example, the light guide member 250 is bondable to the optical connector 130 shown in FIG. 15 described above.

For example, the alignment portion 252 that has a pin configuration is inserted into a hole 132 formed in the optical connector 130.

The optical fiber 113 assembled on the optical connector 130 in the state in which the optical connector 130 is bonded to the light guide member 250 is positioned on an optical axis passing through the center of the lens portion 251. The light-emitting portion or the light receiving portion of the optical element 30 is positioned on the optical axis of the lens portion 251.

By connecting the alignment portion 252 of the light guide member 250 and the hole 132 of the optical connector 130, the movement of the optical connector 130 in the X-axis direction and the Y-axis direction is regulated; and the optical fiber 113 is aligned with respect to the lens portion 251. Or, the alignment portion 252 may be a hole; and a portion that has a pin configuration may be provided in the optical connector 130 and inserted into the alignment portion 252, i.e., the hole.

Also, because the lower surface of the alignment portion 252 contacts the second surface 12 of the silicon substrate 10, the position in the Z-axis direction of the lens portion 251 is determined with respect to the optical element 30. That is, the light guide member 250 is positioned in a direction from the optical element 30 toward the thinned portion 15 by an outside portion of the light guide member 250. The outside portion is outside the via 13 and is continuous to the light guide portion 253.

By the inner wall of the via 13, the movement of the light guide portion 253 in the X-axis direction and the Y-axis direction is regulated; and the positions in the X-axis direction and the Y-axis direction of the lens portion 251 are determined with respect to the optical element 30. That is, the light guide member 250 is positioned in a direction excluding a direction from the optical element 30 toward the thinned portion 15 by the side wall of the silicon substrate 10.

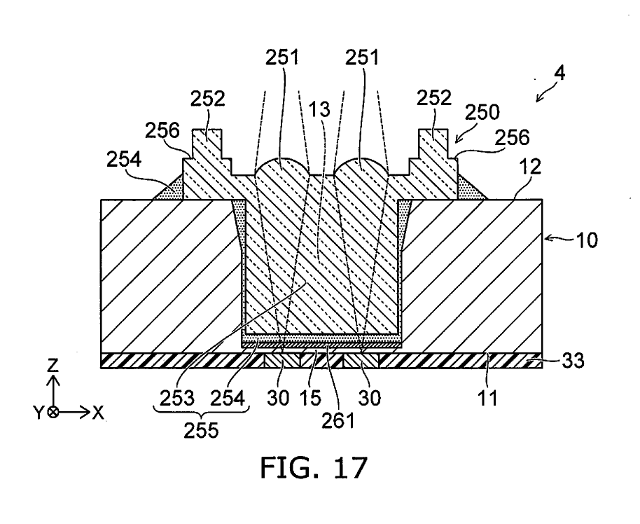

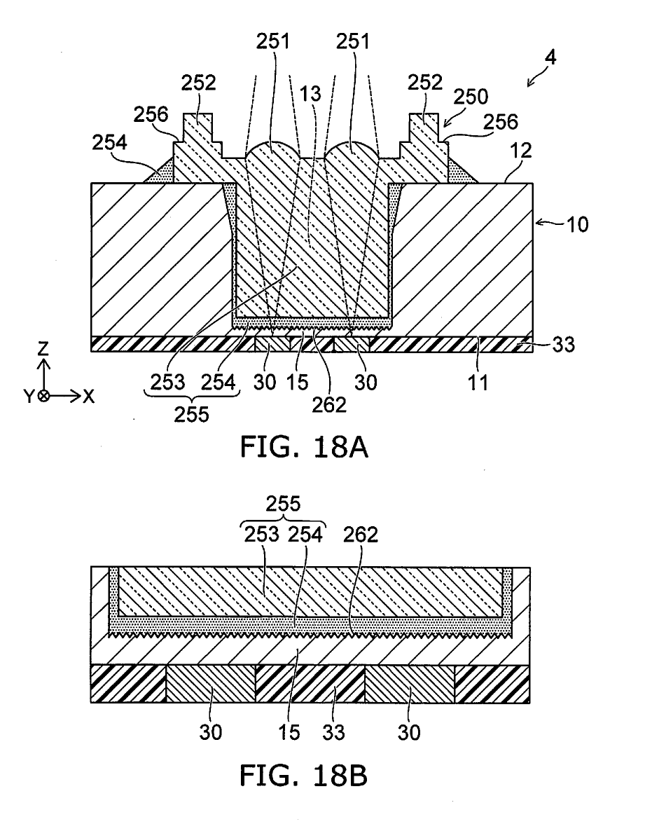

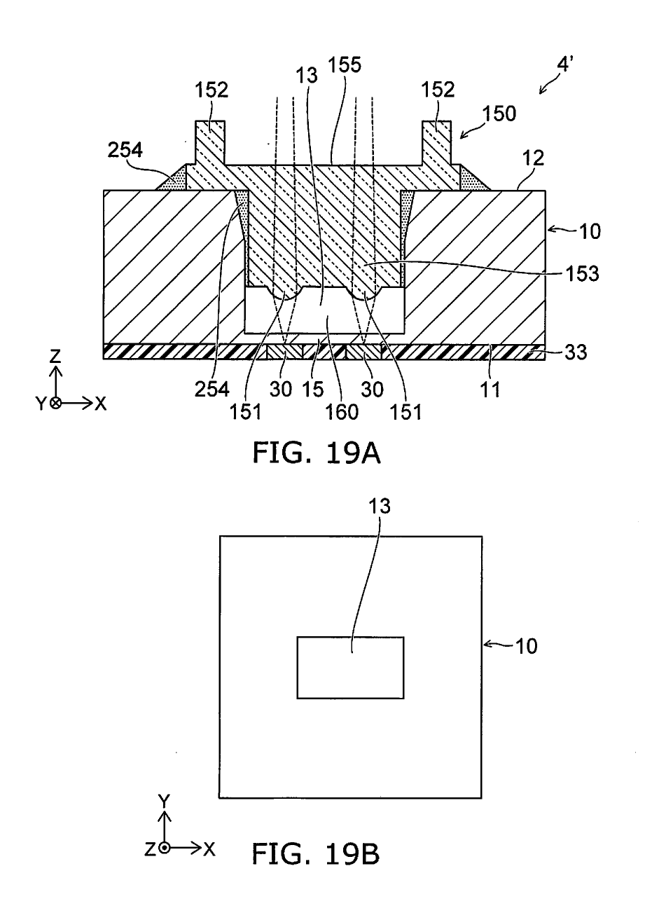

In FIG. 16A, the light rays are schematically illustrated by broken lines. In FIG. 17, FIG. 18A, and FIG. 19A described below as well, the light rays are schematically illustrated by broken lines. For example, the lens portion 251 condenses the light emitted by the optical element 30 that is a light-emitting element toward the end surface of the optical fiber 113. Or, for example, the lens portion 251 condenses the light emitted by the optical fiber 113 toward the light receiving portion of the optical element 30 that is a light receiving element.

FIG. 17 is a schematic cross-sectional view of another example of the optical semiconductor module 4 according to the third embodiment.

In the example shown in FIG. 17, a film 261 that contacts the light guide portion 255 of the light guide member 250 and the thinned portion 15 of the silicon substrate 10 is provided between the light guide portion 255 and the thinned portion 15. The film 261 is provided at the bottom portion of the via 13, i.e., the surface of the thinned portion 15.

The film 261 has the function of an AR (antireflection) film; and the reflectance at the interface between the thinned portion 15 and the transparent bonding agent 254 for the light emitted or received by the optical element 30 is lower than the case where there is no film 261.

A refractive index n_{AR} of such a film 261 can be determined by n_{AR}=(nₚ·nₛᵢ)^{1/2} (nₚ being the refractive index of the transparent bonding agent 254 or the light guide portion 255, and nₛᵢ being the refractive index of silicon). For example, in the case where a wavelength λ of the light emitted or received by the optical element 30 is 1.3 μm, a silicon nitride film (a SiN film) that has a refractive index of 2.3 and a film thickness of 140 nm can be provided as the film 261.

FIG. 18A is a schematic cross-sectional view of another example of the optical semiconductor module 4 according to the third embodiment.

FIG. 18B is an enlarged cross-sectional view of one portion of FIG. 18A.

In the example shown in FIGS. 18A and 18B, an unevenness 262 is provided at the interface between the light guide portion 255 of the light guide member 250 and the thinned portion 15 of the silicon substrate 10. For example, the unevenness 262 is provided at the upper surface of the thinned portion 15. The upper surface of the thinned portion 15 is faced to the light guide portion 255. The unevenness 262 has a pitch that is not longer than the wavelength of the light emitted or received by the optical element 30, and is a SWG (Sub Wavelength Grating) having a tapered configuration in which the width gradually becomes narrow (or becomes finer) toward the light guide portion 255 which has a lower refractive index than the thinned portion 15 which is silicon.

Reflections at the interface between the light guide portion 255 and the thinned portion 15 of the silicon substrate 10 of the light emitted from the optical element 30 or incident on the optical element 30 can be suppressed by the unevenness 262.

FIG. 19A is a schematic cross-sectional view of an optical semiconductor module 4′ according to the third embodiment.

The configuration of a light guide member 150 of the optical semiconductor module 4′ is different from that of the optical semiconductor module 4 shown in FIG. 16A, FIG. 17, and FIG. 18A.

The light guide member 150 includes a lens portion 151, a light guide portion 153, and an alignment portion 152. The material of the light guide member 150 is transmissive to the light emitted or received by the optical element 30. The light guide member 150 is, for example, a resin member in which the lens portion 151, the light guide portion 153, and the alignment portion 152 are provided as one body. The light guide member 150 is, for example, a molded lens adapter obtained by molding a resin material.

The light guide portion 153 and the lens portion 151 are provided inside the via 13 of the silicon substrate 10. The transparent bonding agent 254 is provided between the light guide portion 153 and the side surface of the via 13.

FIG. 19B is a schematic plan view of the silicon substrate 10 of the optical semiconductor module 4′ according to the third embodiment; and the via 13 is provided in the silicon substrate 10. The opening configuration of the via 13 is not limited to a quadrilateral and may be any configuration combinable with the light guide portion 153 such as a triangle, a circle, an ellipse, a hexagon, etc. Here, although the light guide portion 153 of the light guide member 150 is taken to be a quadrilateral prism, a relief portion is not provided in the via 13 so that the transparent bonding agent 254 does not enter an air gap 160 described below when providing the transparent bonding agent 254.

The multiple lens portions 151 that correspond to the multiple optical elements 30 are provided inside one via 13 provided in the silicon substrate 10. The lens portions 151 are, for example, convex lenses.

The direction from the optical element 30 toward the lens portion 151 is aligned with the first direction (the Z-axis direction). The lens portion 151 is provided between the light guide portion 153 and the optical element 30. The thinned portion 15 of the silicon substrate 10 is provided between the lens portion 151 and the optical element 30. The air gap 160 is provided between the lens portion 151 and the thinned portion 15 of the silicon substrate 10.

For example, the light guide member 150 is bondable to the optical connector 130 shown in FIG. 15 described above. For example, the alignment portion 152 that has a pin configuration is inserted into the hole 132 formed in the optical connector 130.

The optical fiber 113 assembled on the optical connector 130 in the state in which the optical connector 130 is bonded to the light guide member 150 is positioned on an optical axis passing through the center of the lens portion 151. The light-emitting portion or the light receiving portion of the optical element 30 is positioned on the optical axis of the lens portion 151. The light guide member 150 has a light incident surface 155 in the region where the optical axis of the lens portion 151 passes through. The end surface of the optical fiber 113 held by the optical connector 130 opposes the light incident surface 155 of the light guide member 150 in the state in which the optical connector 130 is bonded to the light guide member 150.

By connecting the alignment portion 152 of the light guide member 150 and the hole 132 of the optical connector 130, the movement of the optical connector 130 in the X-axis direction and the Y-axis direction is regulated; and the optical fiber 113 is aligned with respect to the lens portion 151. Or, the alignment portion 152 may be a hole; and a portion that has a pin configuration may be provided in the optical connector 130 and inserted into the alignment portion 152, i.e., the hole.

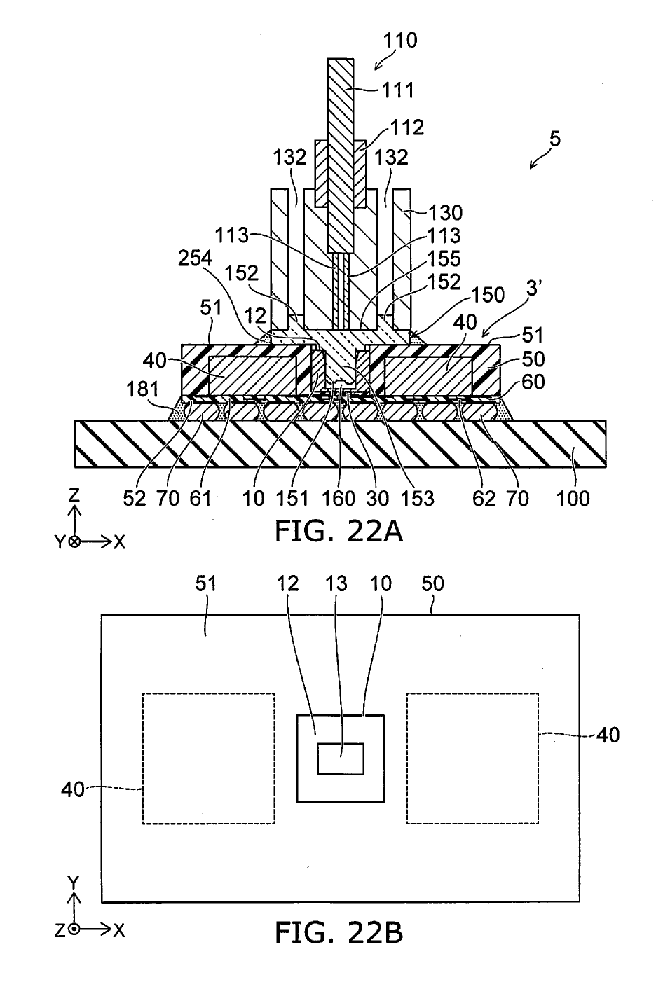

Also, because the lower surface of the alignment portion 152 contacts the second surface 12 of the silicon substrate 10, the position in the Z-axis direction of the lens portion 151 is determined with respect to the optical element 30 by the lower surface of the alignment portion 152 contacting the second resin surface 51 of the resin portion 50 as shown in FIG. 22A described below.

Also, by the inner wall of the via 13, the movement of the light guide portion 153 in the X-axis direction and the Y-axis direction is regulated; and the position in the X-axis direction and the Y-axis direction of the lens portion 151 is determined with respect to the optical element 30.

For example, the lens portion 151 condenses the light emitted by the optical element 30 that is a light-emitting element toward the end surface of the optical fiber 113. Or, the lens portion 151 condenses the light emitted by the optical fiber 113 toward the light receiving portion of the optical element 30 that is, for example, a light receiving element.

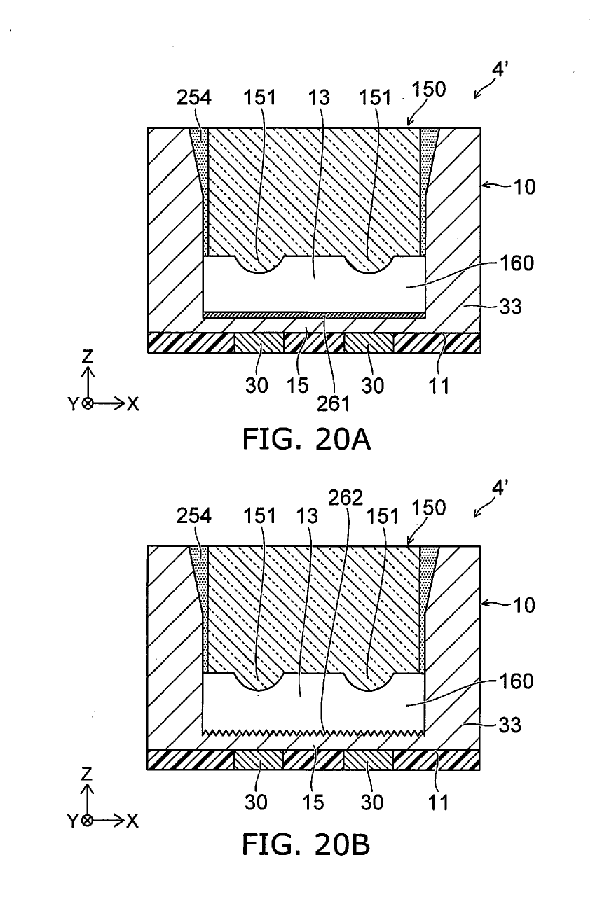

FIG. 20A is a schematic cross-sectional view of another example of the optical semiconductor module 4′.

In the example shown in FIG. 20A, the film 261 is provided at the interface between the air gap 160 and the thinned portion 15 of the silicon substrate 10, i.e., the surface of the thinned portion 15.

The film 261 has the function of an AR (antireflection) film; and the reflectance at the interface between the thinned portion 15 and the air gap 160 for the light emitted or received by the optical element 30 is lower than in the case where there is no film 261.

The refractive index n_{AR} of such film 261 can be determined by n_{AR}=(n₀·nₛᵢ)^{1/2} (n₀ being the refractive index of the air gap, and nₛⱼ being the refractive index of silicon). For example, in the case where the wavelength of the light emitted or received by the optical element 30 is 1.3 μm, a silicon nitride film (a SiN film) that has a refractive index of 1.9 and a film thickness of 170 nm can be provided as the film 261.

FIG. 20B is a schematic cross-sectional view of another example of the optical semiconductor module 4′.

In the example shown in FIG. 20B, the unevenness 262 is provided in the interface between the air gap 160 and the thinned portion 15 of the silicon substrate 10, i.e., the upper surface of the thinned portion 15. The unevenness 262 is provided at the upper surface of the thinned portion 15. The upper surface of the thinned portion 15 is faced to the light guide member 150. For example, the unevenness 262 is provided to have a pitch not longer than the wavelength of the light emitted or received by the optical element 30 and is a SWG (Sub Wavelength Grating) having a tapered configuration in which the width gradually becomes narrow (or becomes finer) toward the air gap 160 which has a lower refractive index than the thinned portion 15 which is silicon.

By the unevenness 262, the reflections at the interface between the air gap 160 and the thinned portion 15 of the silicon substrate 10 of the light emitted from the optical element 30 or incident on the optical element 30 can be suppressed.

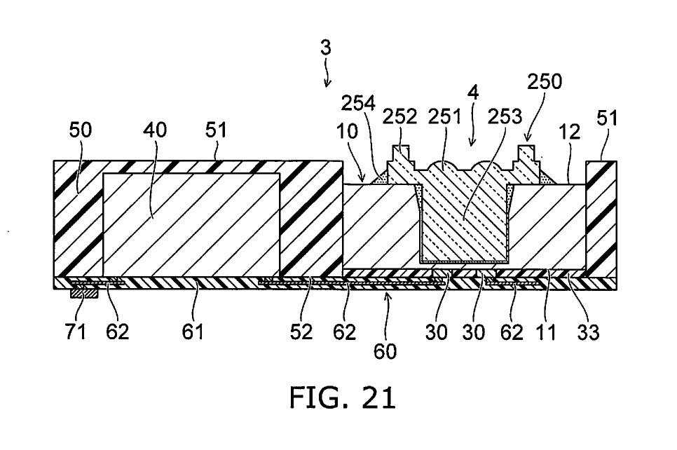

FIG. 21 is a schematic cross-sectional view of an optical semiconductor module 3 according to the third embodiment.

The optical semiconductor module 3 includes at least one of the optical semiconductor module 4 or 4′ shown in FIG. 16A, FIG. 17, FIG. 18A, FIG. 19A, FIG. 19B, FIG. 20A, or FIG. 20B described above. An optical semiconductor module 3 that includes the optical semiconductor module 4 shown in FIG. 16A is illustrated in FIG. 21.

The optical semiconductor module 3 further includes the interconnect layer 60, the semiconductor elements 40, the resin portion 50, and external terminals 71.

The optical semiconductor module 4 and the semiconductor elements 40 are mounted to the interconnect layer 60. The direction from the interconnect layer 60 toward the silicon substrate 10 and the direction from the interconnect layer 60 toward the semiconductor elements 40 are aligned with the first direction (the Z-axis direction). The direction from the silicon substrate 10 toward the semiconductor elements 40 is aligned with the second direction (the X-axis direction).

Although only one is shown in FIG. 21, the multiple external terminals 71 are provided at the surface of the interconnect layer 60 opposite to the surface where the optical semiconductor module 4 and the semiconductor elements 40 are mounted. The external terminals 71 are, for example, metal pads. The external terminals 71 may be solder balls or metal bumps.

The optical element 30 is provided between the interconnect layer 60 and the first surface 11 of the silicon substrate 10. Also, the insulating layer 33 is provided between the first surface 11 and the interconnect layer 60.

The interconnect layer 60 includes the insulating layer 61 and the conductive member 62. The conductive member 62 includes, for example, a metal interconnect. The conductive member 62 is connected to the external terminals 71. The conductive member 62 is further connected to the optical element 30. Accordingly, the optical element 30 is electrically connected to the external terminals 71 via the conductive member 62 of the interconnect layer 60.

The conductive member 62 of the interconnect layer 60 further electrically connects the semiconductor elements 40 and the external terminals 71. The optical element 30 is electrically connected to the semiconductor elements 40 via the conductive member 62 of the interconnect layer 60. The semiconductor elements 40 include, for example, a driver or a receiver of the optical element 30.

The resin portion 50 is provided between the silicon substrate 10 and the semiconductor elements 40. The resin portion 50 covers the semiconductor elements 40. The resin portion 50 further covers the side surface of the silicon substrate 10. The side surface crosses the X-Y plane.

The resin portion 50 does not cover the second surface 12 of the silicon substrate 10. A portion of the resin portion 50 does not overlap the silicon substrate 10 in the first direction (the Z-axis direction).

The resin portion 50 has the first resin surface 52 and the second resin surface 51. The first resin surface 52 opposes the interconnect layer 60 along the first direction (the Z-axis direction). The second resin surface 51 is the surface opposite to the first resin surface 52.

The distance along the Z-axis direction between the interconnect layer 60 and the second resin surface 51 is longer than the distance along the Z-axis direction between the interconnect layer 60 and the second surface 12 of the silicon substrate 10.

As shown in FIG. 22A, the optical semiconductor module 3 can be mounted to the board 100 and bonded to the optical connector 130.

FIG. 22A is a schematic cross-sectional view of the optical semiconductor module 5 according to the third embodiment.

FIG. 22B is a schematic plan view showing an arrangement example of the silicon substrate 10 and the semiconductor elements 40 of the optical semiconductor module 5.

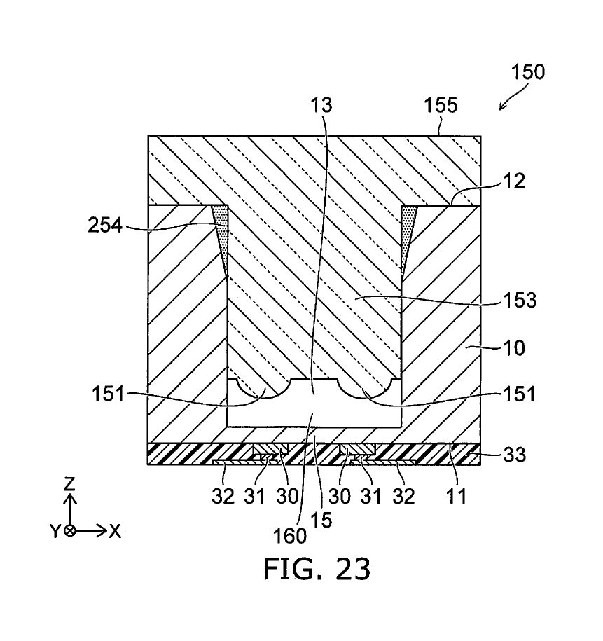

FIG. 23 is an enlarged view of one portion of FIG. 22A.

In FIG. 22A, for example, an optical semiconductor module 3′ that includes the light guide member 150 shown in FIGS. 19A and 19B described above is shown. Also, the film 261 shown in FIG. 20A and/or the unevenness 262 shown in FIG. 20B may be provided at the bottom portion of the via 13, i.e., the upper surface of the thinned portion 15 of the silicon substrate 10. Of course, the optical semiconductor module 4 shown in FIG. 16A, FIG. 17, or FIG. 18A described above may be used.

As shown in FIG. 22A, the optical semiconductor module 3′ is mounted to the board 100. The optical connector 130 is bonded to the optical semiconductor module 3′. The optical connector 130 is assembled on the end portion of the optical fiber cable 110.

The optical semiconductor module 3′ includes the interconnect layer 60, the silicon substrate 10, the optical element 30, the light guide member 150, the multiple semiconductor elements 40, the resin portion 50, and the multiple external terminals 70.

For example, the interconnect layer 60 is aligned with the X-Y plane. The multiple external terminals 70 are arranged in the second direction (the X-axis direction) and the third direction (the Y-axis direction) in the X-Y plane. The external terminals 70 are, for example, solder balls. The external terminals 70 may be metal pads or metal bumps.

The interconnect layer 60 is provided between the silicon substrate 10 and the external terminals 70 and between the external terminals 70 and the semiconductor elements 40.

After forming the optical element 30 at the first surface 11 of the silicon substrate 10, the insulating layer 33 is formed at the first surface 11 of the silicon substrate 10 as shown in FIG. 23; and the optical element 30 may be covered with the insulating layer 33. The metal interconnect 32 that is connected to the electrode 31 of the optical element 30 also can be formed in the insulating layer 33.

The optical element 30 is electrically connected to the external terminals 70 via the electrode 31, the metal interconnect 32, and the conductive member 62 of the interconnect layer 60. The conductive member 62 of the interconnect layer 60 further electrically connects the semiconductor elements 40 and the external terminals 70. The optical element 30 is electrically connected to the semiconductor elements 40 via the conductive member 62 of the interconnect layer 60. The semiconductor elements 40 include, for example, a driver or a receiver of the optical element 30.

The alignment portion 152 of the light guide member 150 is connectable to the optical connector 130 assembled on the edge of the optical fiber 113. For example, the alignment portion 152 that has a pin configuration is inserted into the hole 132 formed in the optical connector 130. Or, a portion that has a pin configuration formed in the optical connector 130 is inserted into the alignment portion 152 which is a hole.

The light guide member 150 has the light incident surface 155 in the region where the optical axis of the lens portion 151 passes through. The end surface of the optical fiber 113 held by the optical connector 130 opposes the light incident surface 155 of the light guide member 150 in the state in which the optical connector 130 is connected to the light guide member 150.

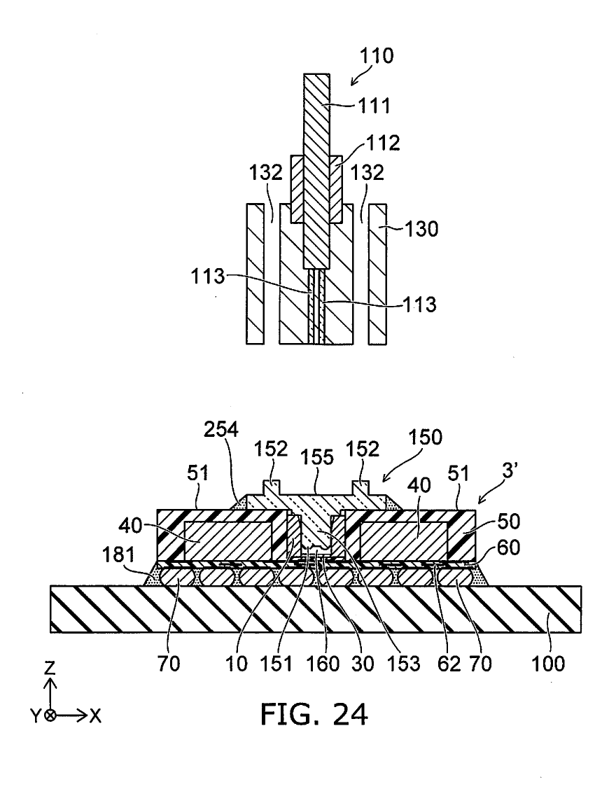

FIG. 24 is a schematic cross-sectional view showing a method for bonding the optical semiconductor module 3′ and the optical fiber 113.

The optical semiconductor module 3′ is mounted to the board 100 before bonding, to the light guide member 150, the optical connector 130 assembled on the edge of the optical fiber 113. For example, the external terminals 70 which are solder balls are reflow-connected to the conductive member of the board 100. The reflow connection that is performed in the state in which the optical connector 130 and the optical fiber 113 are not bonded makes the reflow process easy.

Then, after mounting the optical semiconductor module 3′ to the board 100, the optical connector 130 is connected to the light guide member 150 of the optical semiconductor module 3′.

According to the third embodiment illustrated in FIG. 16A to FIG. 24, the optical fiber 113 can be mounted to the optical semiconductor module 3′ easily without special technology or processes after the board mounting service provider mounts the optical semiconductor module (in FIG. 22A, the optical semiconductor module 3′) to the board 100. It is unnecessary to insert the optical fiber 113 directly into the via 13 of the silicon substrate 10. Due to the simple bonding method between the optical connector 130 and the light guide member 150, the external optical fiber 113 can be optically connected to the optical element 30. This makes it possible to suppress the fluctuation of the optical fiber mounting work quality and to inexpensively provide a highly-reliable assembly.

Also, as shown in FIG. 24, the reflow connection of the optical semiconductor module 3′ to the board 100 that is performed in the state in which the optical connector 130 and the optical fiber 113 are not bonded makes the reflow process easy.

### Note 1

An optical semiconductor module, comprising:

an interconnect layer;

a silicon substrate, a direction from the interconnect layer toward the silicon substrate being aligned with a first direction;

an optical element provided between the interconnect layer and the silicon substrate; and

a light guide portion extending in the first direction through the silicon substrate,

one portion of the silicon substrate being provided so that an air gap is not interposed between the light guide portion and the optical element.

### Note 2

The optical semiconductor module according to Note 1, wherein the light guide portion includes an optical fiber.

### Note 3

The optical semiconductor module according to Note 1, wherein the light guide portion includes a condensing lens.

### Note 4

An optical semiconductor module, comprising:

an interconnect layer;

a silicon substrate; and

an optical element provided between the interconnect layer and the silicon substrate,

the silicon substrate including a diffractive lens provided at a surface opposite to a surface where the optical element is provided.

### Note 5

A method for manufacturing an optical connector head, comprising:

inserting multiple optical fibers into multiple first holes extending in a thickness direction of an optical connector head substrate;

covering, with a sacrificial layer, a portion of the multiple optical fibers protruding from the first hole, and polishing the portion of the multiple optical fibers with the sacrificial layer; and

after removing the sacrificial layer, separating the optical connector head substrate into multiple optical connector heads.

### Note 6

The method for manufacturing the optical connector head according to Note 5, wherein a guide member is press-fit into a second hole extending in a thickness direction of the optical connector head.

Hereinabove, embodiments of the invention are described with reference to specific examples. However, the invention is not limited to these specific examples. One skilled in the art may similarly practice the invention by appropriately selecting specific configurations of components from known art; and such practice is within the scope of the invention to the extent that similar effects can be obtained.

Any two or more components of the specific examples may be combined within the extent of technical feasibility and are within the scope of the invention to the extent that the spirit of the invention is included.

All optical semiconductor modules and methods for manufacturing optical connector heads practicable by an appropriate design modification by one skilled in the art based on the optical semiconductor modules and the methods for manufacturing the optical connector heads described above as the embodiments of the invention also are within the scope of the invention to the extent that the spirit of the invention is included.

Various modifications and alterations within the spirit of the invention will be readily apparent to those skilled in the art; and all such modifications and alterations should be seen as being within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. An optical semiconductor module, comprising:
a silicon substrate including a thinned portion and a side wall provided around the thinned portion, the thinned portion being thinned selectively from one surface of the silicon substrate;
an optical element formed on a surface of the thinned portion, the surface opposite to the one surface of the silicon substrate;
a light guide member including a lens portion, a light guide portion, and an alignment portion, the light guide portion being provided between the lens portion and the optical element, the alignment portion being for an optical connector; and
a transparent resin provided between the thinned portion of the silicon substrate and the light guide portion of the light guide member,
the thinned portion of the silicon substrate being provided between the light guide portion of the light guide member and the optical element,
the light guide member being positioned in a direction excluding a direction from the optical element toward the thinned portion by the side wall of the silicon substrate,
the light guide member being positioned in the direction from the optical element toward the thinned portion by an outside portion of the light guide member, the outside portion being outside a via provided on the thinned portion of the silicon substrate and being continuous to the light guide portion.

2. The module according to claim 1, wherein a plurality of lens portions is arrayed above one via provided on the thinned portion of the silicon substrate.

3. The module according to claim 1, further comprising a film contacting the thinned portion of the silicon substrate, and being provided between the light guide portion and the thinned portion,
a reflectance at an interface between the thinned portion and the film for light emitted or received by the optical element being lower than a reflectance at an interface not including the film between the light guide portion and the thinned portion for the light.

4. The module according to claim 1, wherein an unevenness is provided at a surface faced to the light guide member of the thinned portion of the silicon substrate, the unevenness has a pitch not more than a wavelength of light emitted or received by the optical element.

5. The module according to claim 1, further comprising
a semiconductor element; and
an interconnect layer including a conductive member connecting the semiconductor element and the optical element.

6. The module according to claim 5, further comprising an external terminal connected to the conductive member.

7. An optical semiconductor module, comprising:
a silicon substrate including a thinned portion and a side wall provided around the thinned portion, the thinned portion being thinned selectively from one surface of the silicon substrate;
an optical element formed on a surface of the thinned portion, the surface opposite to the one surface of the silicon substrate; and
a light guide member including a light guide portion, a lens portion, and an alignment portion, the lens portion being provided between the light guide portion and the optical element, the alignment portion being for an optical connector,
the light guide member being positioned in a direction excluding a direction from the optical element toward the thinned portion by the side wall of the silicon substrate,
the light guide member being positioned in the direction from the optical element toward the thinned portion by an outside portion of the light guide member, the outside portion being outside a via provided on the thinned portion of the silicon substrate and being continuous to the light guide portion,
the thinned portion of the silicon substrate being provided between the light guide portion of the light guide member and the optical element,
the lens portion being provided inside the via, and provided between the light guide portion and the thinned portion of the silicon substrate,
an air gap being provided between the lens portion and the thinned portion of the silicon substrate.

8. The module according to claim 7, wherein a plurality of lens portions is arrayed inside one via provided on the thinned portion of the silicon substrate.

9. The module according to claim 7, further comprising a film contacting the thinned portion of the silicon substrate, and being provided between the air gap and the thinned portion,
a reflectance at an interface between the thinned portion and the film for light emitted or received by the optical element being lower than a reflectance at an interface not including the film between the air gap and the thinned portion for the light.

10. The module according to claim 7, wherein an unevenness is provided at a surface faced to the light guide member of the thinned portion of the silicon substrate, the unevenness has a pitch not more than a wavelength of light emitted or received by the optical element.

11. The module according to claim 7, further comprising
a semiconductor element; and
an interconnect layer including a conductive member connecting the semiconductor element and the optical element.

12. The module according to claim 11, further comprising an external terminal connected to the conductive member.

13. An optical semiconductor module, comprising:
the optical semiconductor module according to claim 1; and
an optical connector assembled on an edge of an optical fiber and connected to the alignment portion of the light guide member.

14. The module according to claim 13, wherein the optical fiber is positioned on an optical axis of the lens portion.

15. An optical semiconductor module, comprising:
the optical semiconductor module according to claim 7; and
an optical connector assembled on an edge of an optical fiber and connected to the alignment portion of the light guide member.

16. The module according to claim 15, wherein the optical fiber is positioned on an optical axis of the lens portion.
